(19) United States
(12) Patent Application Publication
(10) Pub. No.: US 2013/0330553 A1
(43) Pub. Date: Dec. 12, 2013

(54) ROD ASSEMBLY AND METHOD FOR FORMING ROD ASSEMBLY

(71) Applicant: Ticona LLC, Florence, KY (US)

(72) Inventors: Aaron Johnson, Winona, MN (US); David Eastep, Winona, MN (US); Richard Stiehm, Winona, MN (US)

(21) Appl. No.: 13/914,900

(22) Filed: Jun. 11, 2013

Related U.S. Application Data
(60) Provisional application No. 61/658,551, filed on Jun. 12, 2012.

(51) Int. Cl. B29C 65/02; D02G 3/22

(52) U.S. Cl. CPC B29C 65/02; D02G 3/22
USPC 428/392; 156/148; 156/166

(57) ABSTRACT

Methods for forming fiber reinforced polymer rod assemblies and fiber reinforced polymer rod assemblies are disclosed. In one embodiment, the method includes heating a portion of a first fiber reinforced polymer rod and heating a portion of a second fiber reinforced polymer rod. The method further includes intertwining the portions of the first fiber reinforced polymer rod and the second fiber reinforced polymer rod to form a rod connecting section. The method further includes aligning the first fiber reinforced polymer rod and the second fiber reinforced polymer rod along a linear axis. The method further includes cooling the portions of the first fiber reinforced polymer rod and the second fiber reinforced polymer rod.

The present application claims filing benefit of U.S. Provisional Patent Application Ser. No. 61/658,551 having a filing date of Jun. 12, 2012, which is incorporated by reference herein in its entirety.

### BACKGROUND OF THE INVENTION

Fiber rovings have been employed in a wide variety of applications. For example, such ravings have been utilized to form fiber-reinforced composite rods. The rods may be utilized as lightweight structural reinforcements. For example, power umbilicals are often used in the transmission of fluids and/or electric signals between the sea surface and equipment located on the sea bed. To help strengthen such umbilicals, attempts have been made to use pultruded carbon fiber rods as separate load carrying elements.

Present manufacturing techniques have improved such that rods having relatively long lengths, and which still exhibit desirable strength properties, can be manufactured. For example, fiber reinforced thermoplastic rods having lengths of up to approximately 5,000 feet can be manufactured in some instances. However, for many applications, longer lengths of rods are required. Rods for use in, for example, undersea power umbilicals may be required to have lengths exceeding 20,000 feet.

Various methods and apparatus for joining rods to form longer rod assemblies are known. However, such methods and apparatus generally cause weakening of the rods at the connection between the rods. For example, mechanical devices and other various methods and apparatus utilized to join rods together may cause misalignments between the fibers in the rods at the connection between the rods. This can significantly weaken the rods at the connection, which can cause failure of the rods during use in various applications.

As such, a need currently exists for an improved method for forming a rod assembly, and for an improved rod assembly. In particular, a need currently exists for a method that results in a rod assembly, and a rod assembly, having improved strength characteristics at the connections between the various rods of the rod assembly.

### SUMMARY OF THE INVENTION

In accordance with one embodiment of the present disclosure, a method for forming a fiber reinforced polymer rod assembly is disclosed. The method includes heating a portion of a first fiber reinforced polymer rod and heating a portion of a second fiber reinforced polymer rod. The method further includes intertwining the portions of the first fiber reinforced polymer rod and the second fiber reinforced polymer rod to form a rod connecting section. The method further includes aligning the first fiber reinforced polymer rod and the second fiber reinforced polymer rod along a linear axis. The method further includes cooling the portions of the first fiber reinforced polymer rod and the second fiber reinforced polymer rod.

In accordance with another embodiment of the present disclosure, a fiber reinforced polymer rod assembly is disclosed. The rod assembly includes a first fiber reinforced polymer rod, a second fiber reinforced polymer rod, and a rod connecting section. The rod connecting section includes overlapping portions of the first fiber reinforced polymer rod and the second fiber reinforced polymer rod, the overlapping portions being intertwined and fused together.

In accordance with another embodiment of the present disclosure, a method for forming a fiber reinforced polymer rod assembly is disclosed. The method includes heating a portion of a first fiber reinforced polymer rod and heating a portion of a second fiber reinforced polymer rod. The method further includes aligning the first fiber reinforced polymer rod and the second fiber reinforced polymer rod along a linear axis such that the portions of the first fiber reinforced polymer rod and the second fiber reinforced polymer rod overlap and are in contact along the linear axis. The method further includes surrounding the portions of the first fiber reinforced polymer rod and the second fiber reinforced polymer rod with a fiber reinforced polymer cuff to form a rod connecting section. The method further includes cooling the portions of the first fiber reinforced polymer rod and the second fiber reinforced polymer rod.

In accordance with another embodiment of the present disclosure, a fiber reinforced polymer rod assembly is disclosed. The rod assembly includes a first fiber reinforced polymer rod, a second fiber reinforced polymer rod, and a rod connecting section. The rod connecting section includes overlapping portions of the first fiber reinforced polymer rod and the second fiber reinforced polymer rod, the overlapping portions being surrounded by a cuff, the overlapping portions and cuff being fused together.

In accordance with another embodiment of the present disclosure, a method for forming a fiber reinforced polymer rod assembly is disclosed. The method includes aligning a first fiber reinforced polymer rod and a second fiber reinforced polymer rod such that a portion of the first fiber reinforced polymer rod and a portion of the second fiber reinforced polymer rod overlap. The method further includes heating the overlapping portion of the first fiber reinforced polymer rod and heating the overlapping portion of the second fiber reinforced polymer rod. The method further includes pressing the overlapping portions of the first fiber reinforced polymer rod and the second fiber reinforced polymer rod together. The method further includes cooling the overlapping portions of the first fiber reinforced polymer rod and the second fiber reinforced polymer rod.

In accordance with another embodiment of the present disclosure, a fiber reinforced polymer rod assembly is disclosed. The rod assembly includes a first fiber reinforced polymer rod, a second fiber reinforced polymer rod, and a rod connecting section. The rod connecting section includes overlapping portions of the first fiber reinforced polymer rod and the second fiber reinforced polymer rod, the overlapping portions being pressed and fused together.

Other features and aspects of the present invention are set forth in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 illustrates a first fiber reinforced polymer rod and a second fiber reinforced polymer rod being heated by a heat source according to one embodiment of the present disclosure;

FIG. 2 illustrates a fiber reinforced polymer rod assembly comprising an intertwined first and second fiber reinforced polymer rod according to one embodiment of the present disclosure;

FIG. 3 illustrates a fiber reinforced polymer rod assembly comprising an intertwined first fiber reinforced polymer rod, second fiber reinforced polymer rod, and third rod according to one embodiment of the present disclosure;

FIG. 4 illustrates a fiber reinforced polymer rod assembly comprising an intertwined first fiber reinforced polymer rod, second fiber reinforced polymer rod, and third rod according to another embodiment of the present disclosure;

FIG. 5 illustrates a fiber reinforced polymer rod assembly comprising an intertwined first and second fiber reinforced polymer rod and a surrounding fiber reinforced polymer cuff according to one embodiment of the present disclosure;

FIG. 6 illustrates a fiber reinforced polymer rod assembly comprising an intertwined first and second fiber reinforced polymer rod and a surrounding fiber reinforced polymer cuff according to another embodiment of the present disclosure;

FIG. 7 illustrates a first fiber reinforced polymer rod and a second fiber reinforced polymer rod being heated by a heat source according to another embodiment of the present disclosure;

FIG. 8 illustrates a first and second fiber reinforced polymer rod being pressed together to form a fiber reinforced polymer rod assembly according to one embodiment of the present disclosure;

FIG. 9 illustrates a fiber reinforced polymer rod assembly comprising a pressed together first and second fiber reinforced polymer rod according to one embodiment of the present disclosure; and

FIG. 10 illustrates a fiber reinforced polymer rod assembly comprising a pressed together and twisted first and second fiber reinforced polymer rod according to one embodiment of the present disclosure.

Repeat use of reference characters in the present specification and drawings is intended to represent the same or analogous features or elements of the present invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention.

Generally speaking, the present disclosure is directed to methods for forming fiber reinforced polymer rod assemblies, and the resulting fiber reinforced polymer rod assemblies. A fiber reinforced polymer rod assembly according to the present disclosure includes multiple fiber reinforced polymer rods. These rods are connected together to form the fiber reinforced polymer rod assembly. In exemplary embodiments, the polymers utilized to form the rods are thermoplastics, such as for example polyphenylene sulfide (“PPS”).

In some exemplary embodiments, the rods of a rod assembly according to the present disclosure are connected by heating, intertwining, and cooling of the rods. For example, portions of the rods may be heated. Heating may be to a temperature generally high enough to soften the polymer material to an extent that the rods can bond, or fuse, together. For example, in some embodiments, portions of the rods may be heated to the melting point for the polymer materials of the rods. These portions may then be intertwined, as discussed herein. The intertwined rods may then be cooled. The resulting rods may be intertwined and fused together to form a rod assembly.

In other exemplary embodiments, the rods of a rod assembly according to the present disclosure are connected by heating, overlapping, surrounding with a fiber reinforced polymer cuff, and cooling. For example, portions of the rods, and the cuff, may be heated. These portions may be overlapped, and the cuff may be positioned surrounding the portions of the rods. The rods, and the cuff, may then be cooled. The resulting rods may be surrounded and fused together, and the cuff may be fused to the rods, to form a rod assembly.

In still other exemplary embodiments, the rods of a rod assembly according to the present disclosure are connected by heating, pressing, and cooling of the rods. For example, portions of the rods may be heating. These portions may then be placed in a die press and pressed together. The pressed together rods may then be cooled. The resulting rods may be pressed and fused together to form a rod assembly.

Connecting of rods to form a rod assembly as disclosed herein may provide improved strength characteristics for the rod assembly. In particular, the present disclosure may provide for improvements in the strength of the rods assembly at the connections between the rods in the rod assemblies. In some exemplary embodiments, these improvements are caused by aligning of the rods along a linear axis during various steps in the forming process, such that the fibers in the rods generally align during the forming process. Tensile forces may additionally be applied to the rods during formation to provide this alignment and resulting improvement in local and overall strength characteristics.

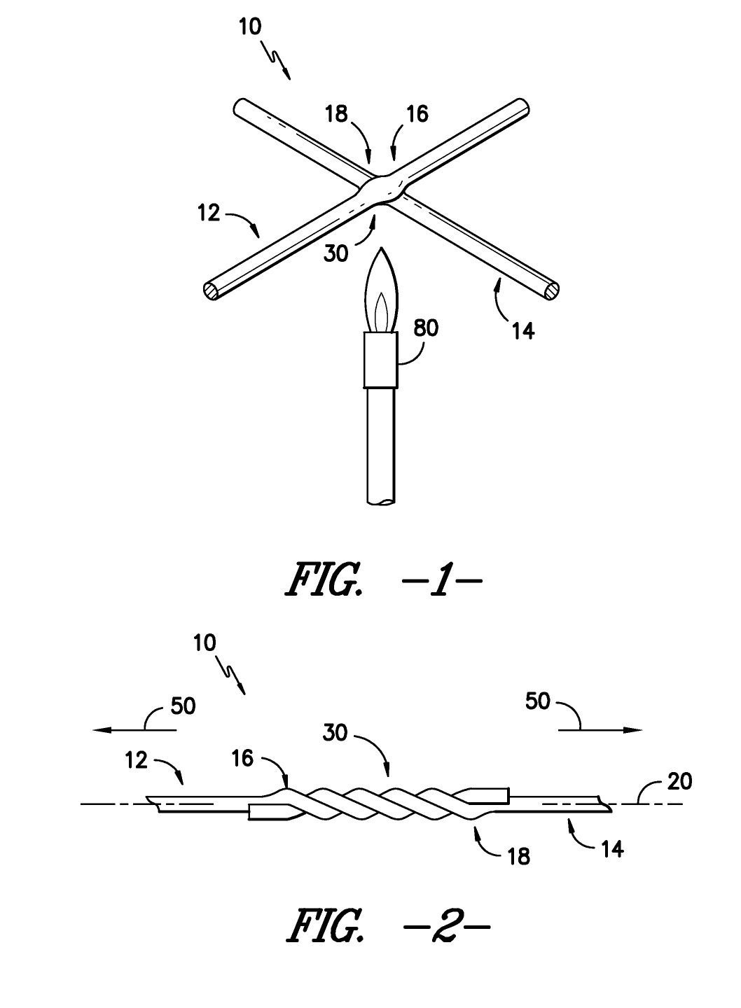

Referring now to FIGS. 1 through 10, various embodiments of a fiber reinforced polymer rod assembly 10 are shown. A fiber reinforced polymer rod assembly 10 includes a plurality of fiber reinforced polymer rods, such as a first fiber reinforced polymer rod 12 and a second fiber reinforced polymer rod 14. A fiber reinforced polymer rod according to the present disclosure is formed from a suitable polymer material, with a plurality of fibers dispersed within the polymer material.

Any of a variety of polymers, such as in exemplary embodiments thermoplastics, may be utilized to form a rod according to the present disclosure. Suitable polymers for use in the present invention may include, for instance, polyolefins (e.g., polypropylene, propylene-ethylene copolymers, etc.), polyesters (e.g., polybutylene terephalate (“PBT”)), polycarbonates, polyamides (e.g., Nylon™), polyether ketones (e.g., polyetherether ketone (“PEEK”)), polyetherimides, polyarylene ketones (e.g., polyphenylene diketone (“PPDK”)), liquid crystal polymers, polyarylene sulfides (e.g., polyphenylene sulfide (“PPS”)), fluoropolymers (e.g., polytetrafluoroethylene-perfluoromethylvinylether polymer, perfluoro-alkoxyalkane polymer, petrafluoroethylene polymer, ethylene-tetrafluoroethylene polymer, etc.), polyacetals, polyurethanes, polycarbonates, styrenic polymers (e.g., acrylonitrile butadiene styrene (“ABS”)), and so forth.

Further, a plurality of fibers are dispersed in the polymer material forming the rod. Thus, the material is a fiber reinforced polymer material. The fibers are in exemplary embodiments continuous fibers, although in other embodiments the fibers may be long fibers. As used therein, the term “long fibers” generally refers to fibers, filaments, yarns, or rovings that are not continuous, and as opposed to “continuous fibers” which generally refer to fibers, filaments, yarns, or ravings having a length that is generally limited only by the length of a part.

The fibers dispersed in the polymer material to form a rod may be formed from any conventional material known in the art, such as metal fibers, glass fibers (e.g., E-glass, A-glass, C-glass, D-glass, AR-glass, R-glass, S1-glass, S2-glass), carbon fibers (e.g., graphite), boron fibers, ceramic fibers (e.g., alumina or silica), aramid fibers (e.g., Kevlar® marketed by E. I. duPont de Nemours, Wilmington, Del.), synthetic organic fibers (e.g., polyamide, polyethylene, paraphenylene, terephthalamide, polyethylene terephthalate and polyphenylene sulfide), and various other natural or synthetic inorganic or organic fibrous materials known for reinforcing polymer compositions. Glass fibers and carbon fibers are particularly desirable for use in the fibers.

Such fibers often have a nominal diameter of about 4 to about 35 micrometers, and in some embodiments, from about 9 to about 35 micrometers. The fibers may be twisted or straight. If desired, the fibers may be in the form of rovings (e.g., bundle of fibers) that contain a single fiber type or different types of fibers. Different fibers may be contained in individual rovings or, alternatively, each roving may contain a different fiber type. For example, in one embodiment, certain rovings may contain carbon fibers, while other rovings may contain glass fibers. The number of fibers contained in each roving can be constant or vary from roving to roving. Typically, a roving may contain from about 1,000 fibers to about 50,000 individual fibers, and in some embodiments, from about 2,000 to about 40,000 fibers.

In some embodiments, an extrusion device may be employed to embed the fibers into the polymer material, in order to minimize the void fraction and ensure good impregnation. Among other things, the extrusion device may facilitate the ability of the polymer to be applied to the entire surface of the fibers. The extrusion device may include, for example, an extruder containing a screw shaft mounted inside a barrel. A heater (e.g., electrical resistance heater) may be mounted outside the barrel. During use, a polymer feedstock, which may be a thermoplastic or a thermoset, is supplied to the extruder through a hopper. The feedstock is conveyed inside the barrel by the screw shaft and heated by frictional forces inside the barrel and by the heater. Upon being heated, the feedstock exits the barrel through a barrel flange and enters a die flange of an impregnation die. Fibers may be supplied to the impregnation die, wherein the fibers are impregnated with polymer material. When processed in this manner, the fiber rovings become embedded in the polymer material, which may be a resin processed from the feedstock. The mixture may then be extruded from the impregnation die to create an extrudate.

The extrusion system may be included in a pultrusion system that is utilized to form a rod according to the present disclosure. For example, the extrudate exiting the impregnation die may be directly supplied to other various components of the pultrusion system. A tension-regulating device may be employed to help control the degree of tension in the extrudate as it is drawn through the pultrusion system. An oven may be supplied in the device for heating the extrudate. The extrudate may then be provided to a consolidation die, which may operate to compress the extrudate together into a preform, and to align and form the initial shape of the desired product. In other words, the consolidation die may shape and form the extrudate into the rod. If desired, a second die (e.g., calibration die) may also be employed that compresses the preform into a final shape of the die. Cooling systems may additionally be incorporated between the dies and/or after either die to cool the rod. A downstream pulling device may be positioned to size the final product and pull the product through the system.

It should be understood, however, that the above disclosed method for forming a rod according to the present disclosure is merely one example of a suitable method, and that any suitable methods and/or apparatus for forming such a rod are within the scope and spirit of the present disclosure.

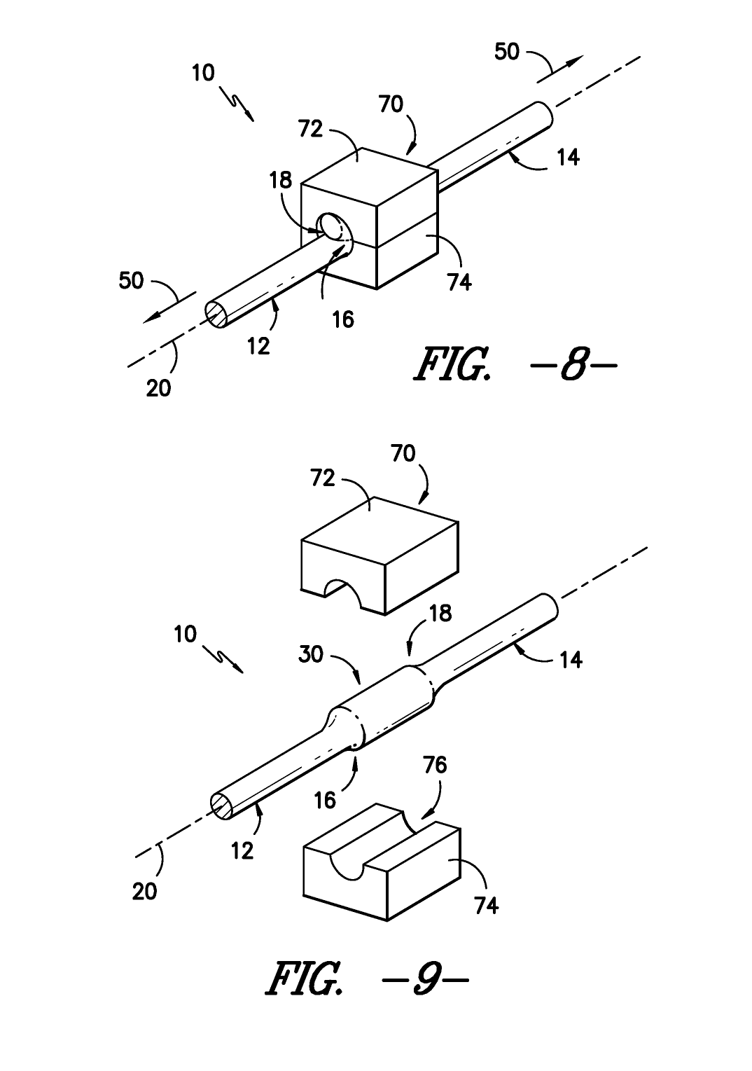

Thus, the rods of a fiber reinforced polymer rod assembly 10 according to the present disclosure are each formed from a suitable polymer material, which in exemplary embodiments is a thermoplastic, with a plurality of fibers dispersed within the polymer material. To form a rod assembly 10, the rods, such as first rod 12 and second rod 14, are heated. As shown in FIGS. 1 and 7, for example, a portion 16 of the first rod 12 and a portion 18 of the second rod 14 may be heated. The portions 16, 18, are the portions of the rods 12, 14 to be manipulated to join the rods 12, 14 together. In exemplary embodiments as shown, the portions 16, 18 are end portions of the first and second rods 12, 14. Further, the portions 16, 18 are in some embodiments overlapping portions, as shown in FIGS. 1 and 7. In some of these embodiments, as shown in FIG. 7 for example, the overlapping portions may be aligned along a linear axis, as discussed below.

The temperature to which the portions 16, 18 of the rods 12, 14 are heated is generally high enough to soften the polymer materials of the rods 12, 14 to an extent that the rods 12, 14, and portions 16, 18 thereof, can bond, or fuse, together. However, the temperature is not so high as to destroy the integrity of the material. The temperature may, for example, range from about 100° C. to about 500° C., in some embodiments from about 200° C. to about 400° C., and in some embodiments, from about 250° C. to about 350° C. Further, in some embodiments, the rods 12, 14, such as the portions 16, 18 thereof, are heated to or above the melting points of the polymer materials thereof. In one particular embodiment, for example, polyphenyiene sulfide (“PPS”) is used as the polymer material, and the portions 16, 18 of the rods 12, 14 are heated to or above the melting point of PPS, which is about 285° C.

It should be understood that the entire portions 16, 18 of the rods 12, 14 need not be heated. Areas of the portions 16, 18 that will be in contact with each other should be heated, such that these areas can fuse together to join the rods 12, 14 and form the rod assembly 10.

Before or after heating of the portions 16, 18 of the rods 12, 14, the rods 12, 14 may in some embodiments be aligned in various specific manners. For example, in some embodiments as shown in FIGS. 1 through 10, the rods 12, 14 may be aligned such that the portions 16, 18 thereof overlap. Further, in some embodiments as shown in FIGS. 2 through 10, the rods 12, 14, such as at least the portions 16, 18 thereof, may be aligned along a linear axis 20. Thus, at least the portions 16, 18 may be positioned generally parallel to the linear axis 20. FIG. 7, for example, illustrates rods 12, 14 overlapping and aligned along a linear axis 20. Aligning of the rods 12, 14 with respect to each other may be performed before, during, or after various other steps described herein. For example, the rods 12, 14 may be aligned before or after heating, in preparation for other joining steps as described below. Alignment of the rods 12, 14 along the linear axis 20 may in some embodiments be of particular importance, because such alignment may generally align the fibers of the rods 12, 14. The fibers of the resulting rod assembly 10 may thus be generally aligned on either side of the connection. Such alignment of the fibers 12, 14 significantly increases the strength of the rod assembly 10, including the connection between the rods 12, 14, thereof.

In some embodiments, as shown in FIGS. 2 through 5, the portions 16, 18 of the first and second rods 12, 14 are intertwined. Intertwining of the portions 16, 18 involves twisting or twining together of the portions 16, 18. Thus, when the portions 16, 18 are intertwined together, each portion 16, 18 is generally wrapped and/or twisted around and/or with the other portion 16, 18, connecting the portions 16, 18 and the rods 12, 14. Such intertwining forms a rod connecting section 30, which includes the intertwined portions 16, 18 of the first and second rods 12, 14.

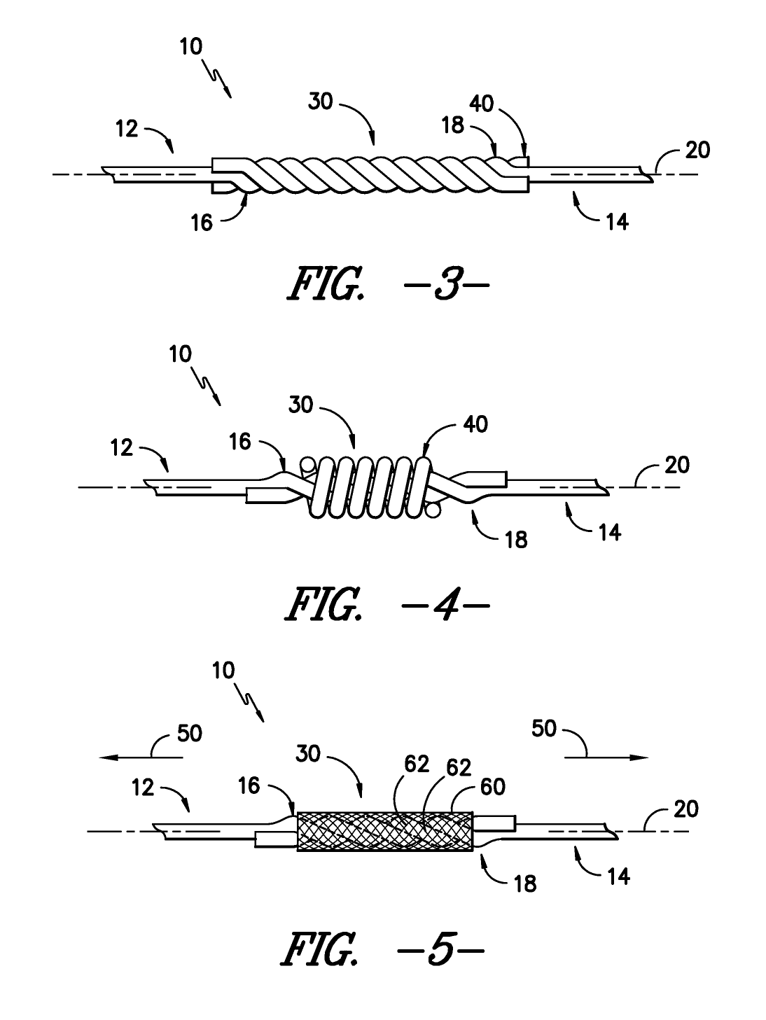

In some embodiments, as shown in FIG. 2, only the portions 16 and 18 of the first and second rods 12, 14 are intertwined. In other embodiments, as shown in FIGS. 3 and 4, a third rod 40 may be intertwined with the first and second rods 12, 14 to further strengthen the rod connecting section 30. The third rod 40 in some embodiments is a fiber reinforced polymer rod. In these embodiments, the third fiber reinforced polymer rod 40 may be formed from any suitable polymer and may have any suitable fibers embedded therein as discussed above. In other embodiments, the third rod 40 may not include any polymer material, and instead be formed from, for example, a suitable fiber material. The third rod 40 in these embodiments may be a string. The fiber material may be formed from any suitable fiber as discussed above, such as in exemplary embodiments poly-paraphenylene terephthalamide (Kevlar™). The rod connecting section 30 may thus include the intertwined portion 16, portion 18, and third rod 40.

In some embodiments, the third rod 40 may be intertwined with the portions 16, 18 during intertwining of the portions 16, 18. The resulting rod connecting section 30 may thus include the third rod 40 intertwined within the portions 16, 18, as shown in FIG. 3. In other embodiments, the third rod 40 may be intertwined with the portions 16, 18 after intertwining of the portions 16, 18. The resulting rod connecting section 30 may thus include the third rod 40 intertwined around the portions 16, 18, as shown in FIG. 4.

In some embodiments, the third rod 40 is heated prior to, during, or after intertwining with the portions 16, 18 of the rods 12, 14. Heating may in some embodiments be to the melting point for the polymer material of the third rod 40, or may to another suitable temperature as discussed above with respect to heating of rods.

In some embodiments, as shown in FIG. 2 by arrows 50, a tensile force may be applied to one or both of the rods 12, 14 generally along the linear axis 20. This tensile force 50 may be applied, for example, before, during, or after intertwining of the portions 16, 18 of the rods 12, 14. Placing the rods 12, 14 in tension during forming of the rod assembly 10 further aligns the fibers of the rods 12, 14, both in the portions 16, 18 and in surrounding portions of the rods 12, 14. This provides further increases in the strength of the rod connecting portion 30 and the rod assembly 10.

The resulting heated and intertwined rods 12, 14, along with optional third rod 40, may thus be in contact, and may thus fuse together. It should be noted that after heating and intertwining of the rods 12, 14, the rods 12, 14 may be cooled. Cooling may solidify the portions 16, 18, and optional third rod 40, thus solidifying the intertwined and fused connections therebetween. Thus, the resulting rod connecting section 30 includes portions 16, 18, and optional third rod 40, that are intertwined and fused together. Intertwining and fusing together of the rods 12, 14 as disclosed herein provides a rod connecting section 30 and a rod assembly 10 with improved strength characteristics. Thus, the method and rod assembly 10 disclosed herein can be utilized with relatively long rods to form relatively long rod assemblies 10 as desired or required.

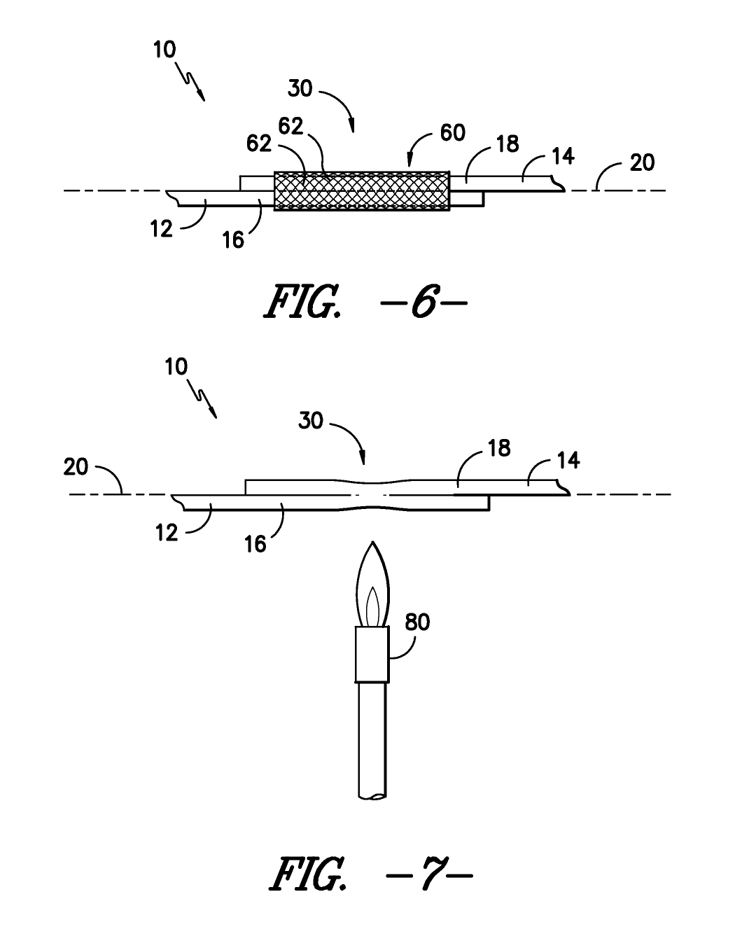

In some embodiments, as shown in FIGS. 5 and 6, the portions 16, 18 may be surrounded with a polymer fiber reinforced cuff 60. The cuff 60 is a generally hollow assembly formed from any suitable polymer and with any suitable fibers embedded therein as discussed above. Further, a cuff 60 may be formed from a plurality of strands 62. Each strand is formed from a suitable polymer with suitable fibers embedded therein. For example, in some embodiments, a strand may be a polymer fiber reinforced roving. The strands 62 may be braided or weaved together to form the cuff 60, as shown. Any suitable number of strands 62 may be utilized to form a cuff 60 according to the present disclosure. In some exemplary embodiments, six strands 62 may be utilized. However, in other embodiments, two, three, four, five, seven, eight or more strands 62 may be utilized.

As shown, a cuff 60 according to the present disclosure may be provided surrounding the portions 16, 18 of the rods 12, 14. In some embodiments, the portions 16, 18 may be interweaved, as shown in FIG. 5. In other embodiments, the portions 16, 18 need not be interweaved. For example, as shown in FIG. 6, the portions 16, 18 may simply be aligned, such as along the linear axis 20, and in contact. Alternatively, the portions 16, 18 may be pressed together, as discussed below. The cuff 60 surrounding the portions 16, 18 may contact the portions 16, 18.

In some embodiments, the cuff 60 is heated prior to, during, or after surrounding of the portions 16, 18 of the rods 12, 14. Heating may in some embodiments be to the melting point for the polymer material of the cuff 60, or may to another suitable temperature as discussed above with respect to heating of rods.

In some embodiments, as shown in FIG. 5 by arrows 50, a tensile force may be applied to one or both of the rods 12, 14 generally along the linear axis 20. This tensile force 50 may be applied, for example, before, during, or after surrounding of the portions 16, 18 of the rods 12, 14 with the cuff 60. Placing the rods 12, 14 in tension during forming of the rod assembly 10 further aligns the fibers of the rods 12, 14, both in the portions 16, 18 and in surrounding portions of the rods 12, 14. This provides further increases in the strength of the rod connecting portion 30 and the rod assembly 10.

The resulting heated and surrounded rods 12, 14, and cuff 60, along with optional third rod 40, may thus be in contact, and may thus fuse together. It should be noted that after heating and surrounding of the rods 12, 14 with the cuff 60, the rods 12, 14 may be cooled. Cooling may solidify the portions 16, 18, the cuff 60, and the optional third rod 40, thus solidifying the surrounded and fused connections therebetween. Thus, the resulting rod connecting section 30 includes portions 16, 18, and cuff 60, and optional third rod 40, that are surrounded and fused together. Surrounding and fusing together of the rods 12, 14 as disclosed herein provides a rod connecting section 30 and a rod assembly 10 with improved strength characteristics. Thus, the method and rod assembly 10 disclosed herein can be utilized with relatively long rods to form relatively long rod assemblies 10 as desired or required.

In some embodiments, as shown in FIGS. 8 through 10, the rods 12, 14, such as the portions 16, 18 thereof, may be pressed together. Pressing may be performed during or after heating of the portions 16, 18 of the rods 12, 14, as discussed above in various embodiments. As shown, for example, a die 70 may be utilized to press the portions 16, 18 together. The die 70 may include, for example, a first die segment 72 and a second die segment 74. A channels defined in one or both die segments 72, 74 may, when the segments 72, 74 are placed in contact, form a passage 76 through the die 70. The rods 12, 14, such as the portions 16, 18 thereof, may be placed between the die segments 72, 74 and pressed together in the passage 76 to press the portions 16, 18 together.

In some embodiments, the die 70 may be a hot die. Thus, one or both of the die segments 72, 74 may be heated, and may thus heat the portions 16, 18, during pressing. As such, heating of the portions 16, 18 is performed during pressing of the portions 16, 18. In other embodiments, the portions 16, 18 are heated separately from the die 70. In these embodiments, heating of the portions 16, 18 is performed before pressing of the portions 16, 18.

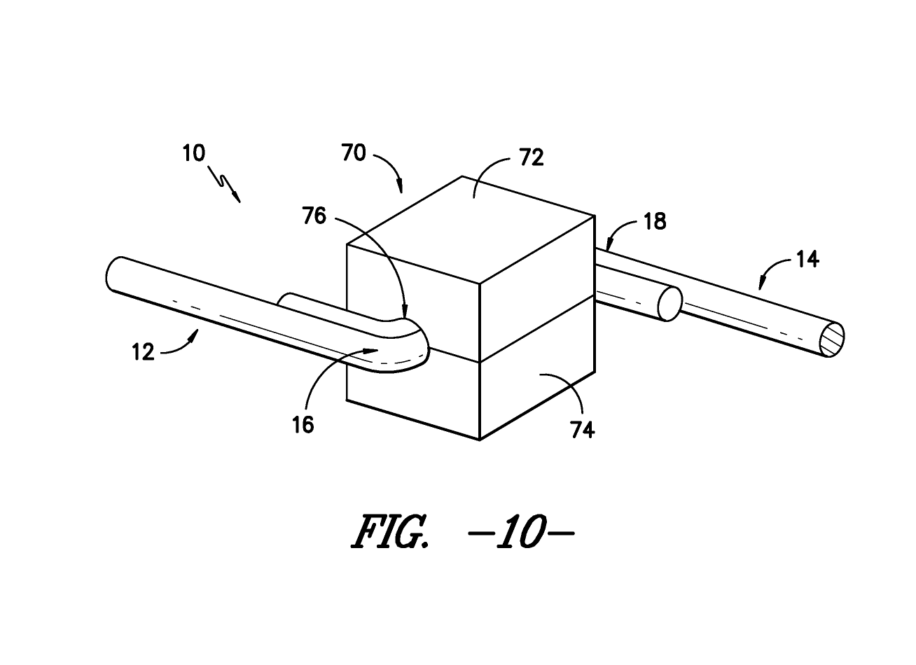

FIG. 8 illustrates one embodiments of the rods 12, 14 in a die 70 during pressing thereof. As discussed, the die 70 may be heated, or the portions 16, 18 of the rods 12, 14 may be heated prior to pressing. FIG. 9 illustrates one embodiment of the rods 12, 14 after pressing. As shown, the portions 16, 18 are pressed and, due to heating, thus fused together.

In some embodiments, as shown in FIG. 8 by arrows 50, a tensile force may be applied to one or both of the rods 12, 14 generally along the linear axis 20. This tensile force 50 may be applied, for example, before, during, or after pressing of the portions 16, 18 of the rods 12, 14. Placing the rods 12, 14 in tension during forming of the rod assembly 10 further aligns the fibers of the rods 12, 14, both in the portions 16, 18 and in surrounding portions of the rods 12, 14. This provides further increases in the strength of the rod connecting portion 30 and the rod assembly 10.

In some embodiments, as shown in FIG. 10, the portions 16, 18 may further be twisted. Twisting may occur before, during as shown in FIG. 10, or after pressing of the portions 16, 18. As shown, in some embodiments, the die 70 may twist the portions 16, 18. For example, the die 70 may, during pressing, also twist about an axis 78. The axis 78 may be, for example, perpendicular to the linear axis 20, or may be at any suitable angle to the linear axis 20. Twisting of the portions 16, 18 in this manner may further facilitate connection of the portions 16, 18 together.

It should further be understood that, in some embodiments, the portions 16, 18 may be intertwined and/or surrounded by a cuff 60, as discussed above, before pressing. Still further, in some embodiments, a third rod 40 may be intertwined with the portions 16, 18 before or after pressing. For example, the third rod 40 may be intertwined with the intertwined portions 16, 18, or may be intertwined around the portions 16, 18 that are not themselves intertwined. The portions 16, 18 and third rod 40 may be heated as discussed above to facilitate contact and fusing thereof.

The resulting heated and pressed rods 12, 14 may thus be in contact, and may thus fuse together. It should be noted that after heating and pressing of the rods 12, 14, the rods 12, 14 may be cooled. Cooling may solidify the portions 16, 18, thus solidifying the pressed and fused connections therebetween. Thus, the resulting rod connecting section 30 includes portions 16, 18 that are pressed and fused together. Pressing and fusing together of the rods 12, 14 as disclosed herein provides a rod connecting section 30 and a rod assembly 10 with improved strength characteristics. Thus, the method and rod assembly 10 disclosed herein can be utilized with relatively long rods to form relatively long rod assemblies 10 as desired or required.

It should be understood that any suitable apparatus may be utilized to perform the various steps disclosed herein for forming a rod assembly 10. For example, any suitable heat source 80 may be utilized to heat the rods 12, 14. Examples of suitable heat sources include open flames, infrared heat sources, laser heat sources, convection heat sources, and induction heat sources. Further, in some embodiments as discussed above wherein a die 70 is utilized, the die 70 may be a heated die, and thus may itself be the heat source.

Suitable apparatus may additionally be utilized to intertwine the rods 12, 14 and/or surround the rods 12, 14 with a cuff 60. For example, the rods 12, 14 may be clamped or otherwise held in a machine, and a component of the machine may twist or otherwise manipulate the portions 16, 18 of the rods 12, 14 to intertwine them, and/or may provide a cuff 60 surrounding the portions 16, 18. Alternatively, intertwining may for example be performed manually.

Suitable apparatus may additionally be utilized to apply tension to the rods 12, 14. For example, the rods 12, 14 may be clamped or otherwise held in a machine, and a component of the machine may pull or otherwise manipulate the rods 12, 14 to apply tension. Alternatively, tensioning may for example be performed manually.

Suitable apparatus may additionally be utilized to cool the rods 12, 14. For example, the rods 12, 14 may be placed in a refrigeration machine or other suitable cooling chamber, or cooling fluid may be applied to the rods 12, 14 by a cooling apparatus. Alternatively, cooling may be performed by otherwise exposing the rods 12, 14 to relatively lower temperatures, such as by simply exposing the rods 12, 14 to ambient temperatures.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A method for forming a fiber reinforced polymer rod assembly, the method comprising:
heating a portion of a first fiber reinforced polymer rod;
heating a portion of a second fiber reinforced polymer rod;
intertwining the portions of the first fiber reinforced polymer rod and the second fiber reinforced polymer rod to form a rod connecting section;
aligning the first fiber reinforced polymer rod and the second fiber reinforced polymer rod along a linear axis; and
cooling the portions of the first fiber reinforced polymer rod and the second fiber reinforced polymer rod.

2. The method of claim 1, further comprising applying a tensile force to the first fiber reinforced rod and the second fiber reinforced rod generally along the linear axis.

3. The method of claim 1, further comprising intertwining a third rod with the portions of the first fiber reinforced polymer rod and the second fiber reinforced polymer rod to form the rod connecting section.

4. The method of claim 3, wherein the third rod is a third fiber reinforced polymer rod.

5. The method of claim 3, wherein the third rod is a fiber string.

6. The method of claim 3, wherein intertwining of the third rod occurs during intertwining of the portions of the first fiber reinforced polymer rod and the second fiber reinforced polymer rod.

7. The method of claim 3, wherein intertwining of the third rod occurs after intertwining of the portions of the first fiber reinforced polymer rod and the second fiber reinforced polymer rod.

8. The method of claim 3, further comprising heating the third rod.

9. The method of claim 1, further comprising surrounding the portions of the first fiber reinforced polymer rod and the second fiber reinforced polymer rod with a fiber reinforced polymer cuff.

10. The method of claim 9, further comprising heating the fiber reinforced polymer cuff.

11. The method of claim 1, wherein the polymer of the first fiber reinforced polymer rod and the polymer of the second fiber reinforced polymer rod are thermoplastics.

12. A method for forming a fiber reinforced polymer rod assembly, the method comprising:
heating a portion of a first fiber reinforced polymer rod;
heating a portion of a second fiber reinforced polymer rod;
aligning the first fiber reinforced polymer rod and the second fiber reinforced polymer rod along a linear axis such that the portions of the first fiber reinforced polymer rod and the second fiber reinforced polymer rod overlap and are in contact along the linear axis;
surrounding the portions of the first fiber reinforced polymer rod and the second fiber reinforced polymer rod with a fiber reinforced polymer cuff to form a rod connecting section; and
cooling the portions of the first fiber reinforced polymer rod and the second fiber reinforced polymer rod.

13. The method of claim 12, further comprising applying a tensile force to the first fiber reinforced rod and the second fiber reinforced rod generally along the linear axis.

14. The method of claim 12, further comprising heating the fiber reinforced polymer cuff.

15. The method of claim 12, wherein the polymer of the first fiber reinforced polymer rod and the polymer of the second fiber reinforced polymer rod are thermoplastics.

16. A fiber reinforced polymer rod assembly, comprising:
a first fiber reinforced polymer rod;
a second fiber reinforced polymer rod;
a rod connecting section comprising overlapping portions of the first fiber reinforced polymer rod and the second fiber reinforced polymer rod, the overlapping portions being intertwined and fused together.

17. The assembly of claim 16, wherein the rod connecting section further comprises a third rod intertwined and fused with the overlapping portions of the first fiber reinforced polymer rod and the second fiber reinforced polymer rod.

18. The assembly of claim 17, wherein the third rod is intertwined within the overlapping portions of the first fiber reinforced polymer rod and the second fiber reinforced polymer rod.

19. The assembly of claim 17, wherein the third rod is intertwined around the overlapping portions of the first fiber reinforced polymer rod and the second fiber reinforced polymer rod.

20. The assembly of claim 16, wherein the rod connecting section further comprises a fiber reinforced polymer cuff surrounding and fused to the overlapping portions of the first fiber reinforced polymer rod and the second fiber reinforced polymer rod.

21. The assembly of claim 16, wherein the polymer of the first fiber reinforced polymer rod and the polymer of the second fiber reinforced polymer rod are thermoplastics.

22. The assembly of claim 16, wherein the overlapping portions of the first fiber reinforced polymer rod and the second fiber reinforced polymer rod are end portions.

23. A method for forming a fiber reinforced polymer rod assembly, the method comprising:
aligning a first fiber reinforced polymer rod and a second fiber reinforced polymer rod such that a portion of the first fiber reinforced polymer rod and a portion of the second fiber reinforced polymer rod overlap; and
heating the overlapping portion of the first fiber reinforced polymer rod;
heating the overlapping portion of the second fiber reinforced polymer rod;
pressing the overlapping portions of the first fiber reinforced polymer rod and the second fiber reinforced polymer rod together; and
cooling the overlapping portions of the first fiber reinforced polymer rod and the second fiber reinforced polymer rod.

24. The method of claim 23, wherein the first fiber reinforced polymer rod and the second fiber reinforced polymer rod are aligned along a linear axis, and wherein the portion of the first fiber reinforced polymer rod and the portion of the second fiber reinforced polymer rod overlap along the linear axis.

25. The method of claim 24, further comprising applying a tensile force to the first fiber reinforced rod and the second fiber reinforced rod generally along the linear axis.

26. The method of claim 23, wherein the heating steps occur during pressing of the overlapping portions.

27. The method of claim 23, wherein the heating steps occur before pressing of the overlapping portions.

28. The method of claim 23, further comprising twisting the overlapping portions of the first fiber reinforced polymer rod and the second fiber reinforced polymer rod.

29. The method of claim 28, wherein the twisting step occurs during the pressing step.

30. The method of claim 28, wherein the overlapping portions are twisted about an axis perpendicular to a linear axis along which the overlapping portions of the first fiber reinforced polymer rod and the second fiber reinforced polymer rod are aligned.

31. The method of claim 23, further comprising intertwining a third rod with the overlapping portions of the first fiber reinforced polymer rod and the second fiber reinforced polymer rod.

32. The method of claim 31, further comprising heating the third rod.

33. The method of claim 31, wherein the intertwining step occurs before the pressing step.

34. The method of claim 23, wherein the polymer of the first fiber reinforced polymer rod and the polymer of the second fiber reinforced polymer rod are thermoplastics.

35. A fiber reinforced polymer rod assembly, comprising:
a first fiber reinforced polymer rod;
a second fiber reinforced polymer rod;
a rod connecting section comprising overlapping portions of the first fiber reinforced polymer rod and the second fiber reinforced polymer rod, the overlapping portions being pressed and fused together.

36. The assembly of claim 35, wherein the overlapping portions are further twisted together.

37. The assembly of claim 35, wherein the rod connecting section further comprises a third rod intertwined and fused with the overlapping portions of the first fiber reinforced polymer rod and the second fiber reinforced polymer rod.

38. The assembly of claim 35, wherein the polymer of the first fiber reinforced polymer rod and the polymer of the second fiber reinforced polymer rod are thermoplastics.

39. The assembly of claim 35, wherein the overlapping portions of the first fiber reinforced polymer rod and the second fiber reinforced polymer rod are end portions.
